(19) United States
(12) Patent Application Publication
(10) Pub. No.: US 2015/0257505 A1
(43) Pub. Date: Sep. 17, 2015

(54) PORTABLE ILLUMINATED CONTAINER

(71) Applicant: Katharine Martinez, Panorama City, CA (US)

(72) Inventor: Katharine Martinez, Panorama City, CA (US)

(21) Appl. No.: 14/205,166

(22) Filed: Mar. 11, 2014

(51) Int. Cl. A45C 15/06; A45C 13/00; F21V 33/00; F21L 4/02; F21L 4/08; F21V 23/02; A45C 1/02; A45C 13/08

(52) U.S. Cl. CPC A45C 15/06; A45C 1/02; A45C 13/005; A45C 13/08; F21L 4/02; F21L 4/08; F21V 23/02; F21V 33/0004; A45C 2200/10; F21Y 2101/02

(57) ABSTRACT

The present invention is directed to a portable container comprising a first section hingedly connected to a second section, each section has walls including a top wall, end walls and a bottom wall. At least a portion of the walls includes an interior panel and an exterior panel spaced apart from each other with the panels connected to each other thereby defining an enclosed space between the panels. The space is filled with particles, lighting sources and a sensor. The sensor detects sound and/or movement and induces the lighting sources to turn on in response to the sound and/or movement. When the lighting sources flash, the particles effect the dispersion of the light as the particles move within the space. Thus, the container serves as a storage container to store the personal items, light up the interior of the container, a means to locate the container, a source of entertainment and a means to locate a user carrying the container from a distance.

### RELATED APPLICATIONS

This application claims priority to U.S. Provisional Patent Application No. 61/931,433, filing on Jan. 24, 2014.

### BACKGROUND OF THE DISCLOSURE

1. Technical Field of the Disclosure

The present embodiment relates in general to portable containers such as purses and clutches to carry one or more items. More particularly, the present embodiment relates to a portable container with a plurality of lighting sources that flash in response to sound and/or movement.

2. Description of the Related Art

Carrying devices such as purses and clutches are used to carry and store a variety of personal items such as make-up items, credit cards, cash, tissues, and glasses. Illuminated carry bags are widely used as an important fashion accessory for evening parties and outings to provide a particular aesthetic look. Such devices also allow one to locate items within the purse or clutch in the dark. Such devices with exterior lighting can also help locate the person holding the purse or clutch in a crowded club or party. Traditional devices for illuminating the interior or exterior of handbags, clutches, or suitcases have utilized individual light bulbs which illuminate only small portions of the handbag immediately adjacent to the light source. These illuminating devices do not disperse light throughout the bag, thereby limiting their usefulness.

Other prior art devices utilize a variety of light bulbs mounted in the various separate interior compartments within the interior of handbags. Such handbags are of complex construction due to the required wiring in each compartment. The bags with lighting units on the bottom side can create discomfort for the user while carrying the bag.

For example, U.S. Pat. No. 4,912,611 issued to Lyle on Mar. 27, 1990 discloses a handbag battery-powered flashlight with a separate control switch that can be rapidly moved from handbag to handbag of either the rigid frame construction or the foldable fabric type. The control switch with actuating arms presses against the sides of the handbag closing the switch contacts whenever the handbag is opened. Both the light source and the control switch have VELCRO, or a similar material, for fastening to the interior surfaces of the handbag. A flexible electrical conductor connecting the light source to the control switch permits moving the light source to various locations for inspecting the external compartments of the handbag as well as illuminating the keyhole in a door or automobile ignition lock. However, the handbag requires the additional control switch to disperse the light to various locations of the handbag. Moreover, the handbag does not include any means to locate a person using the handbag from a distance.

Another example includes U.S. Pat. No. 6,152,572 issued to Cutler on Nov. 28, 2000 describes a handbag interior illumination system for shining light on the contents therein. The handbag interior illumination system includes an elongate flexible tube with a pair of elongate flexible attachment strips coupled to opposite sides of the tube. A light source is disposed in the lumen of the tube. A battery is electrically connected to the light source. The tube is designed for positioning along an periphery of the mouth in a ring shaped configuration such that the proximal end of the tube is positioned adjacent the distal end of the tube. The attachment strips are designed for coupling to the compartment of the handbag. However, the handbag does not provide an even dispersion of light and does not project the light to the exterior. Moreover, the handbag does not provide an elegant or trendy appearance when using it at parties.

Similarly, U.S. Pat. No. 6,499,857 issued to Lumley on Dec. 31, 2002 teaches lighting attached to a clothing accessory article such as a handbag or a high heeled shoe. The clothing accessory article has an exterior surface provided with a plurality of lights dispersed among gem-like members that are illuminated by the lights. The article includes a switch for on/off control of the lights and the switch is disguised as a decorative member on the article. Since the article includes the illumination system along the sides, the entire article is not illuminated evenly. In addition, the article does not include any means to disperse the light emitted by the light sources.

Likewise, U.S. Pat. No. 8,579,459 issued to Ma on Nov. 12, 2013 discloses an illuminated bucket. The illuminated bucket is a double-layered or walled carrier, with LED light, or other illuminated source, established between the layered inner and outer walls for the formed carrier. The circuitry for the LED lights includes a battery, and may further include a flasher that allows for blinking of the lights. However, the illuminated bucket does not include a sensor for detecting a sound and/or movement. Moreover, the bucket does not include any means to disperse the light evenly emitted by the light sources. In addition, the light sources do not flash in response to the sound and/or movement.

Therefore, there is a need for an improved portable container that would be rigid and easily customized to provide an aesthetic appearance. Such a needed portable container would provide a plurality of lighting sources in an enclosed space to radiate light on the interior and exterior panels. Such a container would include a sensor connected to the plurality of lighting sources to detect sound and/or movement and induce the plurality of lighting sources to flash in response to the sound and/or movement. Such a needed device would include a plurality of particles within the enclosed space and when the plurality of lighting sources flash, the plurality of particles is capable of effecting the dispersion of the light as the particles move within the enclosed space while still providing privacy by preventing anyone from having a clear view of the contents of the container as the particles shift in different directions. Such an improved container would be configured in such a way that the plurality of particles move within the enclosed space and the plurality of particles flow in different directions, depending on the orientation of the portable container. Finally, such a portable container would serve as a source of entertainment and a means to locate the user carrying the portable container from a distance. The present disclosure accomplishes these objectives.

### SUMMARY OF THE DISCLOSURE

The present invention is directed to a portable container that is adaptable for carrying one or more items. The portable container comprising a first section hingedly connected to a second section, each section has a plurality of walls including a top wall, a pair of opposing end walls and a bottom wall. The plurality of walls define an interior compartment for storing personal items. At least a portion of the plurality of walls include an interior panel and an exterior panel spaced apart from each other with the interior panel and exterior panel connected to each other thereby defining an enclosed space between the interior panel and exterior panel. The top walls of the first section and the second section include a locking means to lock the portable container when not in use. The enclosed space is filled with a plurality of particles that can be selected from the group consisting of sand, beads, rocks, crystals, semi-precious and precision stones, balls or other small objects, or combinations thereof. The color of the particles should be selected to enhance the desired refraction of the light. The plurality of particles do not completely fill the enclosed space and the plurality of particles can roll or shift within the enclosed space. Thus, the plurality of particles flows in different directions depending upon the movement and orientation of the portable container. The movement of the plurality of particles, depending upon the particle type, can also create sound when a user carries the portable container.

The enclosed space includes a plurality of lighting sources to selectively illuminate the interior panel and the exterior panel. The same lighting sources that illuminate the interior of the container also illuminate the exterior of the container. The interior and exterior panels are constructed from transparent material such as acrylic sheets or other plastic resin material. An inner portion of the bottom wall of the portable container within the enclosed space is releasably connected with at least one rechargeable energy source. The at least one rechargeable energy source is operatively connected with the plurality of lighting sources within the enclosed space. The enclosed space further includes at least one sensor that is releasably attached to the inner portion of the bottom wall. The at least one sensor is operatively connected with the plurality of lighting sources within the enclosed space. The at least one sensor is configured to detect sound and/or movement and induce the plurality of lighting sources to flash in response to the sound and/or movement.

When the lighting sources flash, the plurality of particles disposed within the enclosed space are adapted to effect the dispersion of the light as the plurality of particles move within the enclosed space. The light source is energy efficient because it serves the dual function of illuminating the interior of the container and the exterior of the container thereby eliminating the need for separate lighting sources for interior and exterior use. The lighting sources help locate articles within the container, act as a beacon when lighting up the exterior of the container to locate the person carrying the container or to locate the container itself, and serve as entertainment when flashing in response to movement and/or in response to the beat of music. Since the sensors respond to sound, loud clapping can also help locate the container when it has been misplaced by lighting it up.

The particles not only enhance the dispersion and color of the light, the particles also provide privacy by blocking the view of the interior of the container. A further feature to provide further privacy is the exterior panel includes a graphic design that partially blocks the view of the interior of the container while still allowing light to escape and the particles to be seen. A checker board is an effective graphic design for this purpose, but any graphic design that serves the same function will be effective.

One objective of the invention is to provide a portable container that includes a plurality of lighting sources in an enclosed space to radiate light on the interior and exterior panels so that the same lighting source serves the dual function of illuminating the interior of the container and also illuminating the exterior of the container.

A second objective of the invention is to provide a portable container that can be configured in such a way that a plurality of particles move within an enclosed space and a plurality of particles flow in different direction depending on the movement orientation of the portable container.

A third objective of the invention is to provide a portable container that can detect sound and/or movement and induce a plurality of lighting sources to flash in response to the sound and/or movement.

Another objective of the present invention is to provide a portable container that serves as a storage container to store the personal items, a source of entertainment, lighting for the interior space, and a means to locate a user carrying the portable container from a distance.

Yet another objective of the present invention is to provide a portable container having a means of dispersing the light emitted by the plurality of lighting sources.

Yet another objective of the present invention is to provide a portable container having a means of dispersing the light emitted by the plurality of lighting sources wherein said means can also provide privacy by blocking the view of the interior of the container.

Still another objective of the present invention is to provide a portable container that is rigid and easily customized to provide an aesthetic appearance.

These and other advantages and features of the present invention are described with specificity so as to make the present invention understandable to one of ordinary skill in the art.

### BRIEF DESCRIPTION OF THE DRAWINGS

In order to enhance their clarity and improve understanding of these various elements and embodiments of the invention, elements in the figures have not necessarily been drawn to scale. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a perspective view of a portable container in accordance with a preferred embodiment of the present invention;

FIG. 2 illustrates an inner perspective view of the portable container in accordance with a preferred embodiment of the present invention;

FIG. 3 illustrates an enlarged side perspective view of the portable container in accordance with a preferred embodiment of the present invention;

FIG. 4 is a transparent perspective view of the portable container shown in FIG. 1 in accordance with a preferred embodiment of the present invention; and

FIG. 5 is an enlarged transparent partial view of the portable container shown in FIG. 4 in accordance with a preferred embodiment of the present invention.

### DETAILED DESCRIPTION OF THE INVENTION

The following discussion addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. Finally, many of the steps are presented below in an order intended only as an exemplary embodiment. Unless logically required, no step should be assumed to be required earlier in the process than a later step simply because it is written first in this document.

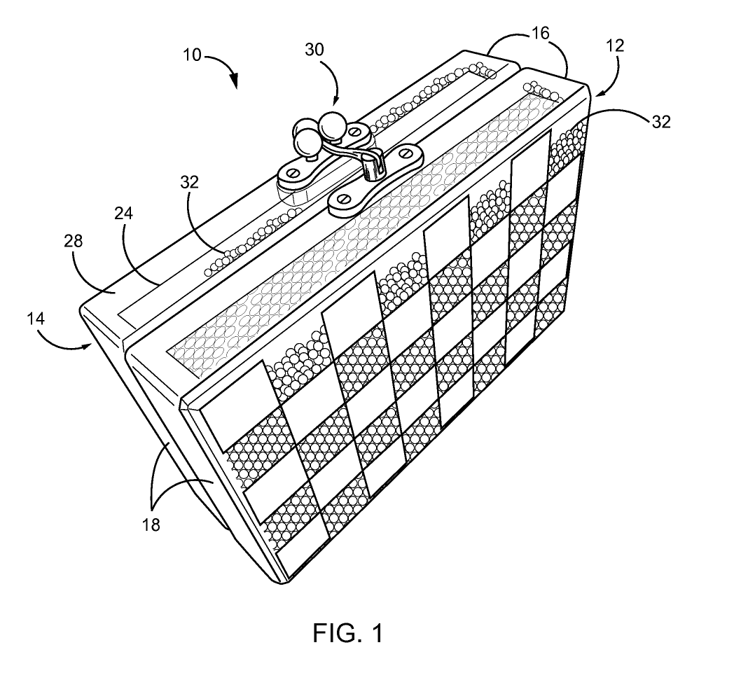

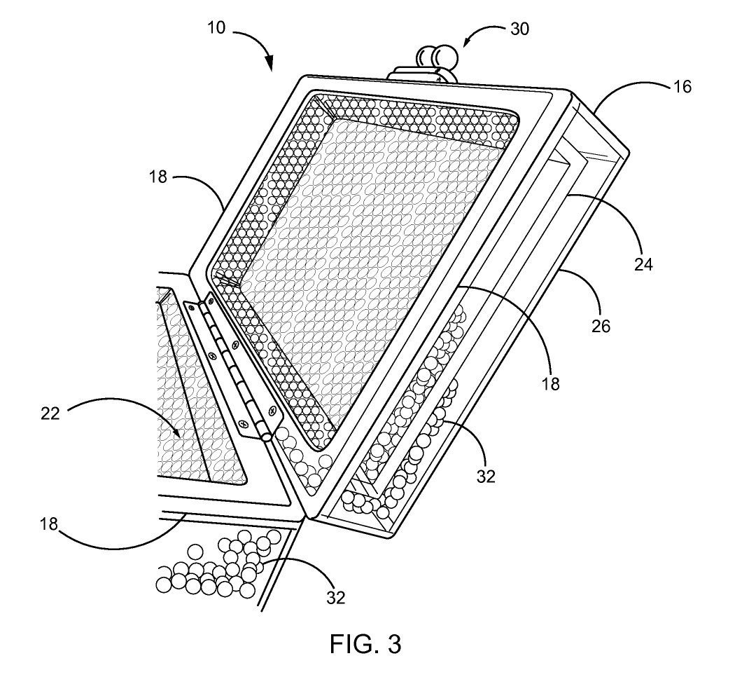

Turning first to FIG. 1, a perspective view of a portable container 10 in accordance with a preferred embodiment of the present invention is illustrated. The portable container 10 is adaptable for carrying one or more items. The portable container 10 comprising a first section 12 hingedly connected to a second section 14, each section 12, 14 has a plurality of walls including a top wall 16, a pair of opposing end walls 18 and a bottom wall 20. The plurality of walls 16, 18, 20 defines an interior compartment 22 for storing the one or more items. At least a portion of the plurality of walls 16, 18, 20 includes an interior panel 24 and an exterior panel 26 (See FIG. 3) spaced apart from each other with the interior panel 24 and exterior panel 26 connected to each other thereby defining an enclosed space 28 between the interior panel 24 and exterior panel 26. The interior and exterior panels 24, 26 are preferably transparent, but at least partially transparent, to permit light to travel through them. For this purpose, they are made of acrylic or other appropriate plastic resin. The exterior panels 26 can also have a graphic design on them to facilitate privacy with respect to the personal contents of the container 10. The graphic design can be any design that allows light to escape such as the checker board pattern 44 show by way of example in FIG. 1. The top walls 16 of the first section 12 and the second section 14 includes a locking means 30 to lock the portable container 10 when not in use.

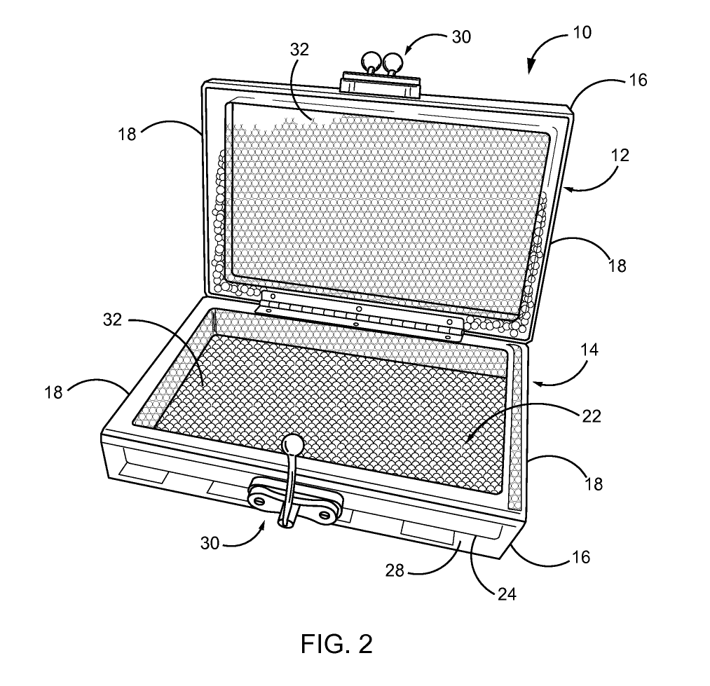

FIGS. 2 and 3 illustrate an inner perspective view and an enlarged side perspective view of the portable container 10 respectively in accordance with a preferred embodiment of the present invention. The enclosed space 28 is filled with a plurality of particles 32 that can be selected from the group consisting of sands, beads, rocks, crystals, balls or other small objects. The plurality of particles 32 does not completely fill the enclosed space 28 and the plurality of particles 32 can move within the enclosed space 28. Thus, the plurality of particles 32 flows in different direction depending on the movement and orientation of the portable container 10. The movement of the plurality of particles 32 creates sound when a user carries the portable container 10.

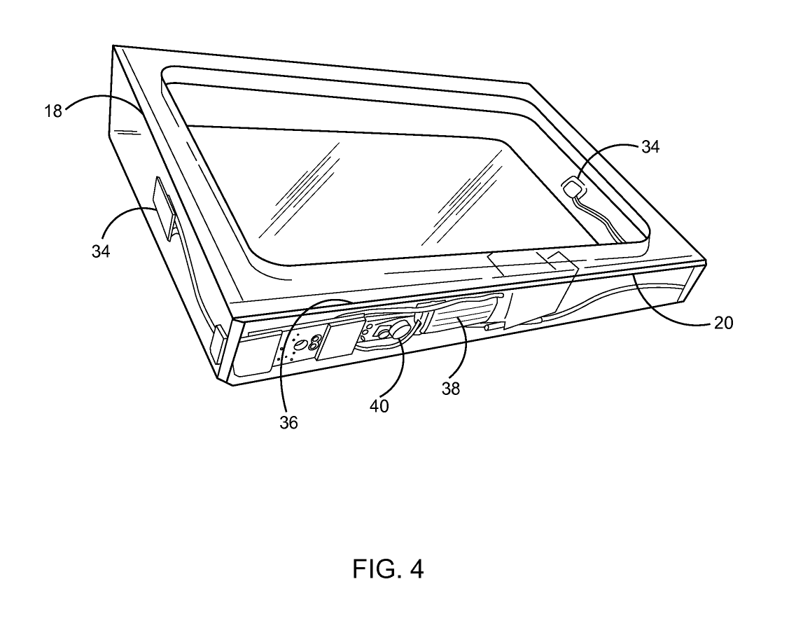

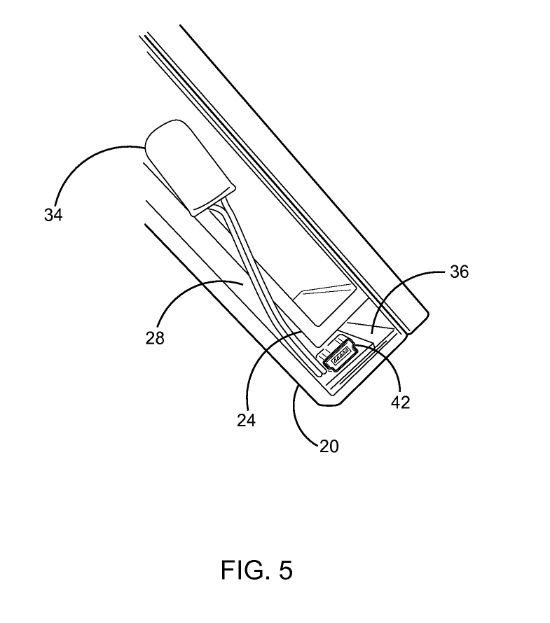

FIGS. 4 and 5 illustrate transparent perspective views of the portable container 10 shown in FIG. 1. The enclosed space 28 includes a plurality of lighting sources 34 to selectively illuminate the interior panel 24 and the exterior panel 26. An inner portion 36 of the bottom wall 20 of the portable container 10 within the enclosed space 28 is releasably connected with at least one rechargeable energy source 38. The at least one rechargeable energy source 38 is operatively connected with the plurality of lighting sources 34 within the enclosed space 28. The enclosed space 28 further includes at least one sensor 40 that is releasably attached in the inner portion 36 of the bottom wall 20. The at least one sensor 40 is operatively connected with the plurality of lighting sources 34 within the enclosed space 28. The at least one sensor 40 is configured to detect sound and/or movement and induce the plurality of lighting sources 34 to light up or flash in response to the sound and/or movement. The plurality of lighting sources 34 within the enclosed space 28 radiates light on the interior panel 24 and the exterior panel 26. When the plurality of lighting sources 34 flash or light up, the plurality of particles 32 disposed within the enclosed space 28 are adapted to effect the dispersion of the light as the plurality of particles 32 move within the enclosed space 28. Thus, the plurality of particles 32 serve as the dispersion means of the light emitted by the plurality of lighting sources 34.

The plurality of lighting sources 34 and the at least one sensor 40 are connected to a universal serial bus (USB) port 42. The USB port 42 is attached at the inner portion 36 of the bottom wall 20 within the enclosed space 28 as shown in FIG. 5. The USB port 42 acts as a charger and also an input source for the control and programming of the plurality of lighting sources 34 and the at least one sensor 40. The USB port 42 is equipped with a USB charger. An USB connector may be a normal, mini, or micro USB connector. The charging current is programmable through the USB port 42. The charging status is indicated by another separate lighting source. The plurality of lighting sources 34 is triggered by the at least one sensor 40. The at least one sensor 40 have programmable sensitivity and can be adjusted through the USB port 42.

The plurality of walls 16, 18, 20 and the interior panel 24 and the exterior panel 26 are made of transparent material to make the enclosed space 28 visible from exterior. The exterior of the portable container 10 can be decorated with different patterns or drawings. The plurality of particles 32 can be customized in any material, shape, and/or color or combination thereof. Beads and sand have been found to be particularly effective as light dispersion means, but crystals, semi-precious stones, precious stones, and other refractive objects can be used.

In one embodiment, the enclosed space 28 includes eight internal light emitting diode (LED) lights, emitting eight different colors, respectively. The plurality of lighting sources 34 may be monochromatic or multi-colored. The plurality of lighting sources 34 comes in many different colors and the user can customize them according to the occasion, if desired. But typically, the plurality of lighting sources 34 are mono-chromatic LED's with 1.7 volts.

In one embodiment, the at least one sensor 40 may be a sound sensor or a motion sensor. The sound sensor detects the sound of music or any sound loud enough to trigger the sensor, and the motion sensor can detect the movement of the container 10. Typically, the motion sensor has an input voltage from 3 to 5 volts and a built in LED driver.

The at least one rechargeable energy sources 38 can be in any specification appropriate to support the plurality of lighting sources 34 and at least one sensor 40 to operate in a reasonable period of time, such as for a period of several days. In one embodiment, the at least one rechargeable energy source 38 is a built-in rechargeable battery. Specifically, the built-in rechargeable battery is a single cell lithium ion battery with 3.7 volts using a current of 110 mA. The at least one rechargeable energy source 38 is selected from a group consisting of an AC to DC power converter, an electric outlet, a universal serial bus (USB) power supply, a replaceable or rechargeable battery, and combinations thereof.

In another embodiment, the plurality of lighting sources 34 are multi-colored LED's. The color can be based, if desired, on the exterior graphics of the portable container 10 thereby matching or contrasting with the exterior graphics. In yet another embodiment, the lighting sources 34 are variety of running LED lights. The running speed, style and colors can be configured according to individual preferences. The LED light sources are also connected to a manual switch that can be turned on or off. Thus, the plurality of lighting sources 34 can be triggered by the at least one sensor 40 or can be maintained on for a prolonged period through controlling the manual switch. In yet another embodiment, the plurality of lighting sources 34 is glowing LED lights.

In some embodiments of the present invention, the portable container 10 includes a built in charger within the interior compartment 22 of the portable container 10 to allow charging of a hand-held communication device (not shown). The at least one rechargeable energy source 38 of the depicted embodiments can store sufficient power to support the at least one sensor 40, the plurality of lighting sources 34 and to provide energy to recharge a cell phone (not shown).

In some embodiments of the present invention, the user (not shown) can move the portable container 10 naturally as the user (not shown) walks while carrying the portable container 10. The change in orientation of the portable container 10 causes the plurality of particles 32 to flow inside the enclosed space 28 and create sound and/or movement. The at least one sensor 40 can detect the movement to trigger the plurality of lighting sources 34 to flash. The plurality of particles 32 can also be made of semi-transparent material. The light emitted by the plurality of lighting sources 34 are subsequently scattered by the plurality of particles 32. Thus, the plurality of particles 32 causes dispersion of the light causing creative lighting effects.

In an exemplary embodiment, the plurality of lighting sources 34 can be triggered by the at least one sensor 40 when the user dances. The at least one sensor 40 detects the rhythm of the music played and the movement of the dancer. The movement triggers the plurality of lighting sources 34 to flash. The light emitted by the plurality of lighting sources 34 are subsequently scattered by the plurality of particles 32. These embodiments illustrate some of the applications, other applications, depending on the ambient sound and the different movements of different situations are also possible. The at least one sensor 40 and the plurality of lighting sources 34 can be programmed in different situations. The sound sensor can be set to respond to the sound of the movement of the particles 32.

The above disclosed portable container 10 serves as a storage container to store the one or more personal items, a source of entertainment and a means to locate the user (not shown) carrying the portable container 10 from a distance. The portable container 10 is selected from the group consisting of: purses, clutches, totes, handbags, carry bags or other storage means. The one or more personal items include at least one selected from the group consisting of: lipstick, chap stick, cellular phone, pill bottle, portable music player, credit cards, cash, key and coins, jewelry, brooch, bronze buckle, concealer, lip gloss, eye shadow, foundation, eye shadow, eyeliner, mascara and blush and rouge and/or combinations thereof.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, the portable container can be included with any means to detect sound and/or movement and the plurality of particles may be customized according to user preferences, for example, size, shape, color and material. It is intended that the scope of the present invention not be limited by this detailed description, but by the claims and the equivalents to the claims appended hereto.

I claim:

1. A portable container comprising:
a first section hingedly connected to a second section, each section having a plurality of walls including a top wall, a pair of opposing end walls and a bottom wall, the plurality of walls defining an interior compartment for storing one or more items, at least a portion of the plurality of walls having an interior panel and an exterior panel spaced apart from each other with the interior and exterior panels connected to each other thereby defining an enclosed space between the interior and exterior panels;
a plurality of lighting sources provided within the enclosed space, the plurality of lighting sources being connected to a rechargeable energy source;
at least one sensor connected to the plurality of lighting sources provided within the enclosed space, the at least one sensor being configured to detect sound and/or movement and the plurality of lighting sources being turned on in response to the sound and/or movement; and
a plurality of particles being disposed within the enclosed space, the plurality of particles being adapted to effect the dispersion of the light as the plurality of particles move within the enclosed space.

2. The portable container of claim 1 wherein the plurality of lighting sources may be light emitting diode (LED) lights.

3. The portable container of claim 1 wherein the at least one sensor may be a motion sensor.

4. The portable container of claim 1 wherein the at least one sensor may be a sound sensor.

5. The portable container of claim 1 wherein the plurality of particles is selected from the group consisting of: sand, beads, pearls, rocks, crystals, semi-precious stones, semi-precious stones, balls or other small items.

6. The portable container of claim 1 wherein the plurality of particles can move within the enclosed space thereby the plurality of particles flows in different direction depending on the orientation of the portable container.

7. The portable container of claim 1 wherein the plurality of walls and the interior and exterior panels are made of transparent material.

8. The portable container of claim 1 wherein the exterior panel includes graphics.

9. The portable container of claim 1 is selected from the group consisting of: purses, clutches, totes, handbags, carry bags or other storage means.

10. The portable container of claim 1 wherein the plurality of lighting sources and the at least one sensor are connected to a universal serial bus (USB) port that acts as a charger and an input source for the control and programming of the plurality of lighting sources and the at least one sensor.

11. The portable container of claim 1 wherein the rechargeable energy source is selected from a group consisting of an AC to DC power converter, electric outlet, a universal serial bus (USB) power supply, a replaceable or rechargeable battery, and combinations thereof.

12. The portable container of claim 1 wherein the portable container further comprises a charger within the interior compartment of the portable container to allow the user to charge a hand-held communication device.

13. A portable container comprising:
a first section hingedly connected to a second section, each section having a plurality of walls including a top wall, a pair of opposing end walls and a bottom wall, the plurality of walls defining an interior compartment for storing one or more items, at least a portion of the plurality of walls having an interior panel and an exterior panel spaced apart from each other with the interior and exterior panels connected to each other thereby defining an enclosed space between the interior and exterior panels;
a plurality of lighting sources provided within the enclosed space to selectively illuminate the interior panel and the exterior panel;
at least one rechargeable energy source operatively connected with the plurality of lighting sources releasably attached in an inner portion of the bottom wall within the enclosed space;
at least one sensor operatively connected with the plurality of lighting sources releasably attached in the inner portion of the bottom wall within the enclosed space, the at least one sensor being configured to detect sound and/or movement and induce the plurality of lighting sources to flash in response to the sound and/or movement; and
a plurality of particles being disposed within the enclosed space, the plurality of particles being adapted to effect the dispersion of the light as the plurality of particles move within the enclosed space;
whereby the portable container serves as a source of entertainment and a means to locate a user carrying the portable container from a distance.

14. The portable container of claim 13 wherein the at least one sensor may be a motion sensor or a sound sensor.

15. The portable container of claim 13 wherein the plurality of particles can move within the enclosed space thereby the plurality of particles flows in different direction depending on the orientation of the portable container.

16. The portable container of claim 13 wherein the plurality of walls and the interior and exterior panels are made of transparent material.

17. The portable container of claim 13 wherein the plurality of lighting sources and the at least one sensor are connected to a universal serial bus (USB) port that acts as a charger and an input source for the control and programming of the plurality of lighting sources and the at least one sensor.

18. A portable container for carrying one or more items, the portable container comprising:
a first section hingedly connected to a second section, each section having a plurality of walls including a top wall, a pair of opposing end walls and a bottom wall, the plurality of walls defining an interior compartment for storing the one or more items, at least a portion of the plurality of walls having an interior panel and an exterior panel spaced apart from each other with the interior and exterior panels connected to each other thereby defining an enclosed space between the interior and exterior panels;
a plurality of lighting sources provided within the enclosed space to selectively illuminate the interior panel and the exterior panel;
at least one rechargeable energy source operatively connected with the plurality of lighting sources releasably attached in an inner portion of the bottom wall within the enclosed space;
at least one sensor operatively connected with the plurality of lighting sources releasably attached in the inner portion of the bottom wall within the enclosed space, the at least one sensor being configured to detect sound and/or movement and induce the plurality of lighting sources to flash in response to the sound and/or movement; and
a plurality of particles being disposed within the enclosed space, the plurality of particles being adapted to effect the dispersion of the light as the plurality of particles move within the enclosed space.

19. The portable container of claim 18 wherein the plurality of particles can move within the enclosed space thereby the plurality of particles flows in different direction depending on the orientation of the portable container.

20. The portable container of claim 18 is selected from the group consisting of: purses, clutches, totes, and handbags.
